(19) United States
(12) Patent Application Publication
(10) Pub. No.: US 2026/0198507 A1
(43) Pub. Date: Jul. 16, 2026

(54) FOOD PRODUCTS AND METHODS OF PREPARATION

(71) Applicant: Rockwell Arthur SMITH, Moonee Ponds, Victoria (AU)

(72) Inventor: Rockwell Arthur SMITH, Moonee Ponds, Victoria (AU)

(21) Appl. No.: 19/127,930

(22) PCT Filed: Nov. 8, 2023
(86) PCT No.: PCT/AU2023/051128

§ 371 Date: May 7, 2025

(30) Foreign Application Priority Data
Nov. 8, 2022 (AU) 2022903340

(51) Int. Cl. A21D 13/41; A21D 2/26; A21D 13/06; A23L 33/19

(52) U.S. Cl. CPC A21D 13/41; A21D 2/26; A21D 13/06; A23L 33/19

(57) ABSTRACT

The present invention relates to human diets and nutrition for improved health and wellbeing. More particularly, the present invention relates to the preparation of foodstuffs which are useful in maintaining a low-carbohydrate food intake, whether for therapeutic purposes, for weight-loss, or as a lifestyle choice. In one form a method of preparing a low-carbohydrate food product is provided, which comprises the steps of:
emulsifying a mixture of egg white with an edible fat/oil by one or a combination of;
blending so as to propagate emulsion throughout the mixture, or; drizzling a thin stream of edible fat/oil into the egg white mixture and mixing to propagate emulsion throughout the mixture; then,
combining a dry protein powder with the emulsified egg white and edible fat/oil mixture to form a dough or batter.

### RELATED APPLICATIONS

This application claims the priority of Australian Provisional Patent Application No. 2022903340 in the name of Rockwell Arthur Smith, which was filed on 8 Nov. 2022, entitled “Foodstuffs and Methods and Systems for Their Production” and the specification thereof is incorporated herein by reference in its entirety and for all purposes.

### FIELD OF INVENTION

The present invention relates to human diets and nutrition for improved health and wellbeing. More particularly, the present invention relates to the preparation of foodstuffs which are useful in maintaining a low-carbohydrate food intake, whether for therapeutic purposes, for weight-loss, or as a lifestyle choice. The invention is particularly suitable to the fields of food supply including frozen foods, long-life and fresh food produce, together with weight management, nutrition, and may be suitable for franchised food outlets. It will be convenient to hereinafter describe the invention in relation to its uses of whey protein concentrate (WPC) as an ingredient in a ketogenic or like diets for the production of a pizza base and similar foodstuffs, however, it should be appreciated that the present invention is not limited to those uses, only.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

The use of a ketogenic diet in the treatment of epilepsy was first described in the 1920s.¹ The ketogenic diet has a high fat content (up to about 90%) and controlled protein and carbohydrate contents. The typical ketogenic diet contains a 4:1 ketogenic ratio or ratio by weight of fat to combined protein and carbohydrate. This is achieved by excluding high-carbohydrate foods such as starchy fruits and vegetables, bread, pasta, grains, and sugar, while increasing the consumption of foods high in fat such as nuts, cream, and butter². This diet is a good alternative for non-surgical pharmacoresistant patients with epilepsy of any age. However, many patients find this high fat/low protein diet to be unpalatable. Moreover, long-term compliance can be problematical for health and lifestyle.

Anecdotally, recipes which have been in circulation, usually on the Internet, attempt to improve the palatability of a high fat diet by focussing on low carbohydrate food alternatives like “keto pizza bases” using egg whites. Typical ingredients for a keto pizza base are:
egg whites; and
one or a combination of coconut flour, oat flour, gluten free oat flour, or almond flour. It is noted that a common recipe provides the option of using either coconut or almond flour. With respect to oat flour and gluten free oat flour, these are not ordinarily used in keto pizza base recipes but are used to make a vegetarian alternative which is also very heavy on the egg whites. Coconut and almond flour may be used as a blend to balance out texture and taste. Essentially, they are fillers and only contribute to the volume; and
spices to taste.

These products taste very “eggy” and are considered not to taste anything like a traditional pizza base or, more generally, the higher carbohydrate food item they aim to replace in the diet. In addition, the texture of the replacement food item tends to be a poor imitation of the original food product it replaces. ¹ Peterman M G, The ketogenic diet in epilepsy, 1925 Jun. 27, Journal of the American Medical Association.² Freeman J M, Kossoff E H, Hartman A L. The ketogenic diet: one decade later. Pediatrics. 2007 Mar; 119(3): 535-43

Another available recipe for keto pizza bases uses a high cheese content and is known as the “fathead dough”. This pizza base has a more natural taste, so it is more palatable or enjoyable with toppings. However, it is un-appetizing when eaten cold, having a chewy texture. Nonetheless, it is considered to be a good keto pizza base alternative.

Keto products may also be produced in the form of breads. Currently available homemade keto breads are produced from fresh ingredients or in the form of a packet mix with fresh ingredients which may be acceptable to some consumers. The homemade options are generally considered to be either too eggy or cheesy in taste. Generally, these are considered good only when toasted, and with that, edible and palatable while still hot. These products may enjoy success in the market as being “low-carb” alternatives. Again, recipes for keto breads have been circulating on the Internet and distributed by traders such as PBCO™ (previously known as The Protein Bread Co.) which makes packet pre-mixes which are commercially available. These products are provided in the market as either online recipes to self-make or use of a premix packet with a few fresh ingredients. One other bread product by Venerdi™ Limited is a small loaf of bread that is ready to eat, which does make it perishable and considering it requires export from New Zealand it becomes comparably expensive in most markets due to logistics, refrigeration etc. Some examples of these products are set out below highlighting the ingredients and cooking method if not premade.

### Fathead Keto Pizza

### Ingredients

1 ½ cups shredded mozzarella cheese
2 oz Cream Cheese
1 large Egg
¾ cup Almond Flour
1tsp Baking Powder
1tsp Italian Seasoning optional

### Method

1. Preheat oven to 425° F.
2. Combine mozzarella cheese and cream cheese in a bowl and microwave for 30 seconds. Take out of the microwave and mix. Microwave for another 30 seconds and mix again.
3. Add almond flour, baking powder, egg, and any herbs and spices to the melted mixture. Mix all the ingredients together with a fork until they combine and begin to cool. Then knead by hand and form into a pizza crust on a non-stick pan. As it can be difficult to shape by hand, preferably, parchment paper may be placed over the crust and rolled with a rolling pin.
4. Bake for 10-12 minutes at 425 degrees. Remove from the oven, add desired toppings and bake for an additional 5-7 minutes.

### 90 Second Keto Bread

### Ingredients

3 tbsp almond flour
1 pinch onion powder
1 pinch sea salt
1/4 tsp baking powder
1 tbsp grated parmesan cheese
1 tbsp grated cheddar cheese
1 tbsp olive oil
1 egg
½ tbsp butter
   Method 1. In a microwave safe dish (about 4.5″ wide) combine the almond flour with the parmesan, grated cheddar, sea salt, onion powder and baking powder. Whisk in the egg and oil until fully combined and then microwave for 90 seconds. It will have puffed up in the microwave and look like a spongy egg creation. 2. Heat butter in a skillet on medium high. Allow ‘bread’ to cool for 2 minutes, then cut in half, horizontally, to form two thinner bread slices. Fry in a skillet until the bread is nice and toasty on both sides. Cool for a couple of minutes before using for burgers or sandwiches.

### PBCo™ Protein Pizza Base—320 g

### Packet Ingredients

Lupin flour
Kibbled sunflower
Flax meal
Whey protein
Almond meal
Sesame seeds
Mixed herbs
Garlic
Onion
Salt

### Extra Ingredients

3 large eggs
60 ml (1/4 cup) water
2 tablespoons olive oil (optional)

### Method—Large Protein Pizza Base

PREPARE—Preheat a fan forced oven to 180° C. and line an extra large baking tray with baking paper (not greaseproof paper).
MIX—Place 80 g (½ cup firmly packed) of packet mix into a large mixing bowl. Add all the extra ingredients and whisk to combine into a smooth liquid batter. For the ultimate crispy pizza base, add the olive oil. Note: this is a batter not a dough. It will be liquid at first-but will crisp up during baking.
POUR—Pour the batter into the centre of the lined tray. Using the back of a spoon, spread the batter to the edges so it's less than ½ cm thick.
BAKE—place in a pre-heated oven and bake for 15-20 minutes or until golden brown, then remove from the oven.
FINISH YOUR PIZZA—Add your favourite pizza toppings, then pop the pizza back into the oven for a further 10-15 minutes or until golden brown on top.
STORAGE—Pizza bases must be store in the fridge (1-4° C.) for up to 5 days or freezer (−18° C.) for up to 3 months.

### VENERDI™ Keto Bread—Hemp & Linseed 490g (ready to Go Pre-made product)

### Ingredients

Water
Coconut oil
Resistance starch (Tapioca)
Free range egg
Green Banana Flour
Ground Linseed (4.6%
Hemp seeds (3.9%)
Almond meal
Psyllium husks
Apple cider vinegar
Coconut flour
Konjac powder (1.4%)
Yeast
Salt
Vegetable gum (Guar gum)
Emulsifier (Sunflower lecithin) Further examples of prior art attempts at improved Keto friendly and low carbohydrate food products are as set out in the following paragraphs.

A “Protein Pizza Base Mix” is disclosed on the Products page of the website www.lovepbco.com (PBCo). The PBCo recipe, including whey protein, requires merely the combining of egg, water and optionally oil with a ‘base’ mix that includes lupin flour, kibbled sunflower, flaxmeal, whey protein, almond meal, sesame seeds, mixed herbs, garlic, onion and salt in the generalised proportions as listed on the webpage before pouring onto a baking tray for cooking a pizza base.

A high protein pizza crust recipe that omits carbohydrates is set out under the heading of “0 Carb Chicken Crust Pizza” on www. thedietchefs. com and ascribed to Joe Duff. This Joe Duff recipe uses unflavoured whey protein powder, again in a straightforward combining of ingredients to produce a batter for cooking a pizza base. The required ingredients include ground chicken, cheese (parmesan) and three eggs, these being the major ingredients for a single pizza crust with unflavoured protein powder as a minor ingredient. However, the recipe also suggests additives of garlic salt and onion powder.

A microwave cooked keto bread preparation is disclosed at the website address of theproteinchef.co (The Protein Chef). According to The Protein Chef, preparation of a microwave keto bread comprises the steps of: mixing melted butter and egg, then mixing in required additional ingredients of almond flour and baking powder and, using a container to shape the mixture and cooking in a microwave. The ingredients list contains a hyperlink for the optional ingredient used in small portion of ‘protein powder’ to an amazon.com page as a source for the whey protein powder. Moreover, this recipe has recommended additional optional ingredients of garlic or other seasoning and an additional large egg to be added with all other ingredients.

A bread recipe ascribed to Paola is disclosed at the website address of www.gnom-gnom. com. Paola discloses a gluten-free paleo-keto-bread with a method of preparing a low-carbohydrate sandwich bread comprising the steps of mixing egg, egg whites, melted butter, yeast and vinegar with an electric mixer, adding dry ingredients including whey protein isolate and mixing to form a dough, shaping the dough with a spatula, and then cooking in an oven.

A method of preparing a keto pizza crust ascribed to Kristie Sullivan is disclosed at the website of www.dietdoctor.com (Sullivan). The method of Sullivan comprises the steps of mixing whey isolate unflavoured protein powder, grated parmesan cheese, mozzarella cheese, cream cheese, olive oil and egg to form a dough, shaping the dough with a spatula or wooden spoon, and cooking the pizza crust (see Ingredients, Instructions at the above noted webpage address).

A gluten-free and grain-free pizza crust recipe is disclosed at the webpage buttoni. wordpress.com (Buttoni). The recipe of Buttoni includes a method of preparing a gluten-free grain free pizza crust comprising the steps of softening cream cheese in a microwave, then mixing the cream cheese with eggs, grated hard (Monterey Jack) and soft (mozzarella) cheese, then mixing in dry ingredients including whey protein powder, shaping the batter into a circle and cooking it (see Ingredients, Directions at the above noted webpage address).

WO 2020/051527 (Same Same Creamery LLC) discloses preparation of ketogenic pastry products using liquid forms of whey protein. For instance, Example 11 is directed to a ketogenic bread comprising a mixture of WPC 80 and butter. Example 12 is directed to ketogenic dough comprising a mixture of cheese curds, WPC 80 and liquid eggs. Example 13 is directed to ketogenic dough comprising a mixture of barrel cheddar, cream cheese, olive oil and WPC 80. However, WO 2020/051527 uses only liquid forms of protein and does not address the drawbacks of requiring additives, for instance, fillers, stabilisers, to provide an acceptable and stable low carbohydrate food product.

A recipe and preparation of ‘Fat Head Bagels’ is disclosed at www.abalancedyou.com (Jim Brown) comprising the steps of melting soft cheese, namely, goat cheese or cream cheese, and grated hard cheese in a microwave, mixing in egg, then mixing in the dry ingredients including whey protein powder. The dough is shaped like a bagel and then cooked. Coconut oil is used to prevent the dough sticking.

At www.verywellfit.com a recipe for “soul bread” ascribed to Lindsey Hyland (Lindsey) is disclosed. The recipe of Lindsey comprises the steps of, softening cream cheese and butter in a microwave, combining cream cheese, butter, olive oil, and eggs and blending using a stick blender, adding the wet ingredients to the dry ingredients which include whey protein powder to form a batter (see Ingredients, Instructions at the above noted webpage address). The batter is shaped in a bread pan and cooked. The ‘Recipe Variations’section notes that the recipe can be used as muffins or a pizza crust.

A recipe for a “Low-Carb Soy Flour Pizza Crust” at www.verywellfit.com discloses a method of preparing a low-carbohydrate pizza comprising the steps of: whisking eggs, olive oil and water together with a fork, adding the wet ingredients to the dry ingredients which include neutral-tasting whey protein powder, shaping the dough and baking (see Ingredients, Preparation at the above noted webpage address).

Overall, it is considered that none of the prior art discussed above adequately addresses the drawbacks of requiring additives, for instance, fillers, stabilisers, and, the overuse of egg as an ingredient, to provide an acceptable and stable low carbohydrate food product providing essential nutrients with its fat and/or protein content that also provides a taste and texture that closely approximates that of the higher carbohydrate food product it replaces with a minimum of essential ingredients.

The prior art food products are also deficient in their make-up for sustaining energy levels of a consumer throughout the course of a day to keep the consumer from being hungry for longer in a day. Prior art food products are considered Keto-friendly in that are simply more likely to be classed as low carbohydrate.

Accordingly, there remains a need for a simplified food product and a simple method of its preparation in which the protein and or fats content are optimised to be directed to achieving homeostasis for a lifestyle diet that does not require additives to synthesise a healthy food product and which provides a texture commensurate with the predominantly carbohydrate food items being replaced.

The preceding discussion of background art is intended to facilitate an understanding of the present invention only. The discussion is not an acknowledgement or admission that any of the material referred to is or was part of the common general knowledge as at the priority date of the application.

### SUMMARY OF INVENTION

An object of the present invention is to provide a system and method of food product preparation that alleviates at least one disadvantage associated with the prior art.

In general, the present invention provides a method of preparing a low-carbohydrate food product comprising the steps of:
emulsifying a mixture of egg white with an edible fat/oil by one or a combination of;
   blending so as to propagate emulsion throughout the mixture, or;
   drizzling a thin stream of edible fat/oil into the egg white mixture and mixing to propagate emulsion throughout the mixture; then,
combining a dry protein powder with the emulsified egg white and edible fat/oil mixture to form one of a dough or a batter.

In a number of embodiments, the mixture of egg white includes egg yolk.

In one embodiment, the steps of emulsifying and combining are performed with a stick blender and, preferably, the temperature of the egg white mixture is in the range of about 30° C. to about 40° C. In this respect, preferably the step of drizzling comprises applying a thin stream of the edible fat/oil into the egg white mixture at a rate in the range of about 0.5 ml per second to about 1.0 ml per second.

In other preferred embodiment, the steps of emulsifying and combining are performed without a stick blender.

Preferably, the edible fat/oil comprises one or a combination of:
monounsaturated fats;
polyunsaturated fats;
essential fatty acids, and;
saturated fats.

Preferably, the dry protein powder comprises one or a combination of:
whey protein concentrate;
WPC;
WPC80;
WPC90;
whey protein isolate;
whey protein hydrolysate;
protein hydrolysate;
spirulina;
casein protein;
egg protein;
fava bean protein;
pea protein;
hemp protein;
brown rice protein, and;
mixed plant proteins.

In preferred forms, the present invention also provides a product of the disclosed process, namely, a low-carbohydrate food product comprising a mixture of egg white with an edible fat/oil wherein the food product is prepared in accordance with the method steps as disclosed herein.

Preferably, the methods as disclosed herein further comprise the steps of:
shaping the dough or batter, and;
cooking the dough or batter.

Preferably, the method steps disclosed herein are performed with a blender or a mixer, wherein the blender or mixer is a stick blender and hand mixer, respectively.

In one aspect of embodiments described herein there is provided a method of preparing a low-carbohydrate food product comprising the step of combining whey protein concentrate and/or other protein concentrate powders with foodstuff ingredients comprising one or a combination of:
egg white;
egg yolk;
edible fats or oils comprising at least one of sesame seed oil, olive oil, butter, and;
at least one cheese.

In other embodiments, the edible fats/oils may comprise by way of example, walnut oil, macadamia nut oil, and coconut oil.

The step of combining whey protein concentrate and/or other protein concentrate powders with the foodstuff ingredients may be performed after mixing or combining the foodstuff ingredients.

The edible fats or oils preferably comprise one or a combination of:
monounsaturated fats;
polyunsaturated fats;
essential fatty acids, and;
saturated fats.

Preferably, the step of combining the whey protein concentrate and/or other protein concentrate powders with the foodstuff ingredients forms a dough or batter.

The method may further comprise the steps of:
shaping the dough or batter, and;
cooking the dough or batter.

The whey protein concentrate preferably comprises WPC80 but may also comprise and other protein concentrates like Fava bean (Faba bean/broad bean) or spirulina powders which can also be 80% concentrate. These alternate protein concentrates provide a complete food ingredient in as much as they too can provide all of the essential amino acid requirements for a healthy diet.

The foodstuff ingredients may include the edible fats or oils and one or more of egg white and egg yolk, wherein the method further includes the step of:
preparing the egg and edible fats or oils for combining with the whey protein concentrate and/or other protein concentrate powders by an emulsification process.

The step of preparing the egg and edible fats or oils for combining may performed with a blender or a mixer. The blender or mixer may be a stick blender and hand mixer, respectively.

The foodstuff ingredients may include at least one cheese, wherein the method further includes the step of:
preparing the at least one cheese for combining with the whey protein concentrate and/or other protein concentrate powders by melting the at least one cheese.

The step of preparing may be performed using a microwave oven or a double boiling/bain-marie technique.

The step of preparing may include adding grated hard cheese to melted soft or semi-soft cheese.

In another aspect of embodiments described herein, a low-carbohydrate food product is provided that includes:
foodstuff ingredients comprising one or a combination of egg white, egg yolk, at least one cheese, and edible fats or oils including at least one of sesame seed oil, olive oil, and butter; and, whey protein concentrate and/or other protein concentrate powders.

The whey protein concentrate preferably comprises WPC80 and/or other protein concentrates like Fava bean (Faba bean/broad bean) or spirulina powders which may also be at 80% concentrate and, the edible fats or oils may comprise one or a combination of:
monounsaturated fats;
polyunsaturated fats;
essential fatty acids, and;
saturated fats.

In yet a further aspect of embodiments described herein there is provided foodstuffs and methods of preparing same that include dry protein powders but not limited to WPC or WPC80 for instance, as other protein powders can be substituted or blended to form foodstuffs in accordance with embodiments of the invention.

Other aspects and preferred forms are disclosed in the specification and/or defined in the appended claims, forming a part of the description of the invention.

In essence, embodiments of the present invention stem from the realisation that substitutes for traditional wheat flour based foods may be readily provided by the combining of a complete protein concentrate powder with a firstly prepared or precursor substance in which this substance can be either emulsified egg whites and edible fats and/or cold pressed oils, or a warmed and folded cheese to create a melted, stable, thick liquid. In particular, it has been realised that dry high percentage protein concentrates can be used as a main ingredient, in contrast to prior art, which only used such ingredients as minor components due to the resulting dryness in the finished products, by the advance of emulsifying oil so as to capture a mixture having a dense moisture for the resultant low carbohydrate food products. Embodiments of the present invention can transform high-carbohydrate foods such as pizza into a ketogenic food which is high in fats, coupled with a high protein content as well. Pizza bases according to embodiments of the present invention prove more palatable than some alternative ketogenic options. Embodiments of the present invention accordingly transform popular “junk” foods such as pizza into “health” foods. Other “comfort” foods according to embodiments of the present invention include breakfast slices, boiled dumplings, lasagne sheets, toast (breakfast slice), crackers and pie/quiche bases. With bread-like products according to embodiments of the present invention, a fan forced oven grill cooking process cooks the emulsified egg white and whey protein concentrate and/or other protein concentrate powders to an expanded base that, once cooled down, can be vacuum packed and dry stored.

Advantages provided by the present invention comprise the following:
The present invention provides for a replacement of a range of flour-based products with products which have a relatively high protein content and complete essential protein profile;
The present invention replaces a range of flour-based products with products which have high levels of healthy fats as alternatives. In this respect, embodiments of the present invention use monounsaturated fats (MUFA) and saturated fats (SFA);
The present invention provides a high-protein foodstuff which is flavoursome both when hot and/or cold. Advantageously, the present invention may provide a healthy, flavoursome, replacement for some junk foods;
By use of higher grade dry proteins, which contain less lactose and fats, the solubility of the protein increases when making the food products of embodiments. Providing dry high % protein concentrates to be used as a main ingredient. This is in contrast to the prior art, which only used such ingredients as minor ingredients due to the resulting dryness in the finished products. However, this has been overcome by emulsifying oil, trapping in the dense moisture into the food products of the embodiments.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE EXAMPLES

Further disclosure, objects, advantages, and aspects of preferred and other embodiments of the present invention may be better understood by those skilled in the relevant art by reference to the following description of embodiments taken in conjunction with the accompanying examples, which are given by way of illustration only, and thus are not limitative of the disclosure herein, and in which:
EXAMPLE. 1 is an exemplary foodstuff preparation process for a batter or dough according to a first embodiment of the present invention.
EXAMPLE. 2 is an exemplary foodstuff preparation process for a thin pizza base according to another aspect of a first embodiment of the present invention.
EXAMPLE. 3 is an exemplary foodstuff preparation process for a focaccia according to yet another aspect of a first embodiment of the present invention.
EXAMPLE. 4 is an exemplary foodstuff preparation process for a pie or quiche according to yet another aspect of a first embodiment of the present invention.
EXAMPLE. 5 is an exemplary foodstuff preparation process for an ‘egg white-only’ pizza base according to yet another aspect of a first embodiment of the present invention.
EXAMPLE. 6 is an exemplary foodstuff preparation process for a ‘bread loaf’ according to yet another aspect of a first embodiment of the present invention.
EXAMPLE. 7 is an exemplary foodstuff preparation process for a dough according to a second embodiment of the present invention.
EXAMPLE. 8 is an exemplary foodstuff preparation process for crackers according to another aspect of a second embodiment of the present invention.
EXAMPLE. 9 is an exemplary foodstuff preparation process for a lasagne sheet according to a further aspect of a second embodiment of the present invention.
EXAMPLE. 10 is an exemplary foodstuff preparation process for a ‘dumpling coating’ according to yet another aspect of a first embodiment of the present invention.
EXAMPLE. 11 is an exemplary foodstuff preparation process for a ‘dessert cake’ according to yet another aspect of a first embodiment of the present invention.

### DETAILED DESCRIPTION

Various embodiments of the present invention, which by way of the disclosed examples, comprise the use of whey protein concentrate. In all embodiments of the present invention, dry protein powder is used as a substantial ingredient in the preparation of low carbohydrate food products. Preferred embodiments employ the particular use of whey protein concentrate 80 (WPC 80 ) as an at least partial replacement for carbohydrates in foods. For the purposes of the present disclosure, reference to WPC80 means the whey protein concentrate which results from when liquid whey is collected as a by-product of cheese or yogurt production and undergoes several processing steps to increase its protein content. After a sufficient protein concentration is achieved, the liquid can be dried to form whey protein concentrate powder that consists of up to 80% protein by weight, at least in the case of WPC80.

As noted, suitable forms of dry protein powders may include whey proteins for use with the present invention. There are three primary types of whey protein supplements: whey protein concentrate (WPC), whey protein isolate, and whey protein hydrolysate.

Whey Protein Concentrate (WPC): WPC is the most cost-effective among the three whey protein powders, containing a protein content range of approximately 58% to 89%. It includes fat, lactose, and immune-enhancing peptides as additional components. The protein concentration can vary from about 50% to about 90%, making it suitable for beginners looking to start an exercise regimen, individuals aiming to build muscle, and those seeking to gain weight.

Whey Protein Isolate: Whey protein isolate boasts a high protein concentration, typically around 95%, with minimal lactose and fat content, approximately 5%. It is ideal for individuals who wish to exercise while closely controlling their carbohydrate and fat intake, focusing on developing lean and well-defined muscles.

Whey Protein Hydrolysate: Whey protein hydrolysate is the most expensive of all whey proteins and contains an exceptionally high protein concentration of around 99%. Through the process of hydrolysis, the molecules are broken down to enhance absorption and digestion by the body. This form of whey protein is highly water-soluble and rapidly absorbed, making it beneficial for nutrition support, immune system enhancement, and improving the quality of life for those with ailments such as for instance, cancer patients. For these reasons it is considered the top choice among whey protein supplements.

It is to be appreciated that a higher percentage whey protein containing less lactose and fats make them a more readily combinable cooking ingredient. Providing dry high percentage protein concentrates to be used as a main ingredient, sits in contrast to the prior art, which only used such ingredients as minor components due to the resulting dryness in the finished products. This, however, has been overcome by the emulsifying of oil so as to trap into the mixture the dense moisture for the food products of embodiments.

There are essentially two core processes involved in embodiments of the present invention described herein as first and second embodiments of the invention, respectively, where the two processes are differentiated by the use of, inter alia, egg as an ingredient on the one hand, and by the use of, inter alia, cheese as an ingredient on the other hand. In the first embodiment and its various aspects, dry protein powder, e.g., WPC80, is being added to a “mayo” combination of emulsified egg white and oil (MUFA)/fats (SFA) whereas, in the second embodiment and its various aspects, dry protein powder, e.g., WPC80, is being added to melted cheeses such as for example, mozzarella and parmesan cheese.

With preferred embodiments of the invention, and with particular reference to using MUFAs, for the method of preparation of the foodstuffs described herein, it is preferable that the mixing container is narrow enough so that the volume of liquid ingredients used covers the head of the stick when using a blender making it fully submerged allowing the emulsification process to start practically instantly. An even narrower container is beneficial as it reduces the manual workload due to the stick blender being able to create a vortex by circulating the ingredients thoroughly as they thicken.

### Progressive Development of Embodiments of the Invention

The present invention provides a product that has been developed over a number of trials and experimentation. The very first version of a foodstuff produced in accordance with embodiments of the invention was inspired by Keto mayonnaise consisting of one egg and one cup of olive oil with a goal being to increase fats in the diet. Once the egg and olive oil (or an equivalent MUFA) were emulsified together, seasoning was added and then the WPC80 was folded through, until a solid thick batter was created. Next the batter was spread out evenly on grease proof paper in a pizza shape to cook in the microwave for about 1 minute. With this, although, the first few versions were a thicker single base, version two allowed for creation of two thinner versions of a pizza base. This change allowed the flavours of the pizza toppings to now dominate the overall taste of the pizza and the thinner base did not make the consumer of the food feel as full as quickly either. Another challenge faced was the denseness and heaviness of the product. This was overcome in version three of the product by aerating the olive oil. This may be achieved by introducing pressurised carbon dioxide such as by use of a Soda Stream ™ water aerator. It is envisaged that other means for aerating may be applied to the oil. Such aerating produces more air pockets creating a lighter texture.

Version four was something of a breakthrough, as the early steps proved very technically complex with a high failure rate. In this version, if the mix did fail, then slowly drizzling the failed mixture into/with a fresh egg was found to be successful in saving the batch and retaining its usefulness. Using this knowledge with the fourth version, a single thin base was produced from using one egg but half of the amount of olive oil. Version four has near zero failure rate and proved to be a faster method due to it condensing the first four steps into one step. The ability to condense steps 1 to 4 worked as it uses only olive oil (MUFA) rather than mixing with (SFA). Butter was incorporated into the later versions which negated the ability to condense steps 1 to 4. Further, as the olive oil presented a dominant taste with previous versions, it was decided to adjust to an oil ratio of ⅔ olive oil to 1/3 coconut oil. This adjustment greatly improved the flavour. Notably, as the coconut oil is Saturated Fat (SFA), it cannot be aerated as this turns the fat into a solid.

With version six the problem of denseness and heaviness of the product that was improved by version three was further addressed, and this was done by swapping the cooking process from the microwave to grill at about 190° C. for around 1 minute still. This version improved the texture, so the microwave was no longer used. With version seven it was decided to explore a different SFA for flavour as coconut oil was better suited to sweet over savory which allowed for the pie recipe to be a sweet crust for the likes of cheese cake (however, it was decided to stop pursuing sweet due to no suitable sweeteners) and butter suited savory better and helped lighten the flavour and also further improved the texture.

In all previous versions the seasoning was added always just before adding the WPC80, with version eight, seasoning is now added just before cooking it under the grill after it has been spread evenly on the grease proof paper. This change allowed the spice flavours to dominate the flavour more, rather than being lost when mixed through in previous versions. To help improve the flavour further in version nine, sesame seed oil is now added to the egg white and grated parmesan cheese on top of the spices before going under the grill, these final improvements allowed for a fuller and more delicious flavour across the range of version offered by the first embodiment, which is referred to as part of the disclosure of “core process 1”.

Around version eight of the product the inventor had been trying for some time to create a chip/cracker product with the core process of the first embodiment, but then adopted a technique from the fathead dough recipe process to create a second embodiment of the invention, which was referred to as core process 2. This started off using 100g of mozzarella cheese melted and then mixed with 75 g of WPC 80 until a dough ball is formed. The dough ball is then flattened and rolled out, then seasoned, cut into smaller pieces, microwaved, and then air fried. After being rolled out, this product can also be used as a lasagne sheet replacement. This made a cracker like product but due to its thickness it was a little chewy. With version two the inventor used a pasta roller after it was rolled out manually to create a thinner and crunchier cracker which worked well. To help enhance the flavour, 25 g of parmesan cheese was used in version 3 with the mozzarella after it is melted. Turning to core process 1, the inventor was mindful of a goal to continue to improve the flavour and texture without compromising on the health/quality. Version 10 came with some unexpected surprises, as the inventor started by using a liquid smoke in the pizza sauce, but then considered why not try smoking the WPC80 to see if the smoky element could be achieved that way and not only did it add a woodfired oven profile it also dramatically improved the texture and flexibility of the product. As the flavour was now smoky throughout, the need for spices were not required and could be better used in the pizza sauce. Version 11 crystallised a past retired observation by chance, when a blend of WPC80 and Fava bean was used to make a pizza base, as more than one protein powder was being used it was decided to mix them together thoroughly and in this base baking powder was also added but unlike previous attempts, of just adding the baking powder with the WPC80 to the suitable mixing container without pre-blending. The step though of thoroughly mixing the baking powder with the protein powder first, allowed the baking powder to react as was always anticipated. This resulted in a lighter. fluffier texture and more flavour and this paved the way for the more traditional bread like texture, which had been the aim. Fava bean has also been used as the only dry ingredient and all ratios in between of varying blends have been tested, using a 1/8 cup with WPC 80 as the 2nd dry ingredient. Proof of concept was also achieved with spirulina for the protein powder in both core process 1 and 2 but WPC 80 still stands as a preferred protein powder for the embodiments. Now that core process 1 was able to be aerated successfully the inventor wanted to make a more traditional burger bun as the inventor was using a rectangle breakfast slice for the buns, due to shaping 6 small circles to be buns was far too much work. The inventor then thought that as the batter/dough moved around easily, but could be tacky, a 2^{nd} oiled sheet of baking paper could be used over the top and a small blob of batter/dough could be pressed with a 21 cm diameter tin lid, the top sheet could then be peeled off and sprinkled with herbs and cheese before cooking. The outcome was quick and easy buns thanks to use of moulds and presses, which would also speed up pizza base making. Now that an understanding was gained for getting a beneficial reaction between the baking powder and the WPC80, the inventor wanted to achieve a bread loaf substitute. This took several failed attempts but during these attempts bicarbonate of soda was substituted for baking powder as this was the main active ingredient with mainly fillers (rice flour). The main challenge with the failed attempts was the crust would form and hinder the bread from rising. The inventor first overcame this by letting the bread proof over an hour, where the loaf volumized and then it cooked in about 5 to 10 minutes. As satisfactory as this was, it still was an undesirable process due to the time frames. In trying to speed the time frames up, the inventor tried speeding up the proofing process with a just warm oven and this helped, this showed that low heat will still activate the raw product, so that it is stable and solid. Through this lens the inventor then explored a lower temperature range for baking vs cooking with grill and the optimal temperature range for baking is about 120-130 degrees Celsius for times in the range of about 25 to 35 minutes, and now no proofing is required, as the lower temperature lets the ingredients react to each other and rise before the hard crust is formed, which now takes longer due to lower heat. The revelation with getting a rise in the product could not have timed better as the inventor had just found a possible healthier sugar alternative, which let the inventor re-explore the desserts/sweets space. The sugar alternative is soluble dietary fibre and prebiotic consisting of Oligofructose/Fructo-oligosaccharides (FOS) powder, and it just gets added to the blend of other dry ingredients before getting mixed with the emulsified wet mix. The final product will be like a cake, and you also can toast the slice of cake in an air fryer to enhance the flavour and texture, shorter times can give more of a brownie texture vs longer times can lead to more of a biscuit texture when air frying.

The present invention with its embodiments now has a product range of various pizza bases, focaccia (this may be used as a toast substitute, sliced into soldiers, or diced into croutons), bread loaf, burger buns, a pie crust, dumplings, dessert bread/cakes, crackers, and lasagne sheets. With the benefit of the invention at hand, variations of these products that are not disclosed herein may be appreciated by the person skilled in the art.

It is to be appreciated that the following 3 techniques are beneficial for certain outcomes, in as much as they form further embodiments. The drizzling of oil, the warming of the egg and separating the white from the yolk, can all help to create a thicker mix. The emulsification process will still work with the appropriate mixer and container. However, if using other mixing equipment to achieve the emulsification process, these 3 techniques may help. Furthermore, a stick blender with a blade mixer requires a suitable container, in which the blender's head is submerged by the volume of liquid ingredients or if a bench mixer with eggbeater/whisk mixers is used, then egg temperature and the need to drizzle in the liquid fats is required for a successful emulsification process to occur.

### EXAMPLES

The following examples are provided in accordance with preferred embodiments of the present invention.

### Example 1

A ‘core process’ for producing a foodstuff such as a base or dough in accordance with a first embodiment of the invention is as follows:

### Ingredients

1 egg
120 ml (½ cup) of edible oil/fats (MUFAs, PUFAs, & SFAs)
50 g (5 % cup) of WPC 80 or other protein concentrates

### Method

1. Separate the egg white from the yolk and place the egg white and ½ cup of the edible oil/fats (ideally MUFAs) into a suitable mixing container such as a Sistema® 656 ml medium soup mug. If more than one type of edible oil/fats is used, try to layer them rather than blend them.
2. In the suitable mixing container blend the egg white and ½ cup of the edible oil/fats (ideally MUFAs) with an electric stick blender/hand mixer for 30 seconds, starting on the bottom and moving it along the bottom as it instantly starts emulsifying where you are mixing, then move to an up and down motion until the mixture gets completely thick.
3. Add the egg yolk and mix for a further period of about 20 to about 30 seconds, this will thin out the thicker emulsified texture to a slightly runnier
4. Fold in the whey protein concentrate until it is thoroughly mixed through to form a batter/dough. Note that the mixture is now ready to cook either by using an oven or air-fryer to bake or grill, microwave to cook and activate or stovetop to boil. For best results spread bases in 3 mm thicknesses on grease proof paper or on an item to be coated. Other than boiling on a stove top, continue with the steps, as follows.
5. Spread the batter/dough accordingly either by hand or using 2 sheets of oiled baking paper to press out manually or press into a mould.
6. For an optimal result use a chopping board to transport the baking paper and prepared product to a rack under an oven's grill to cook @180 degrees Celsius for about 1 to 2 minutes until puffy and golden or in the oven @ 125 degree Celsius until puffy and starting to colour, which takes approximately 15 to 20 minutes.

It is to be noted that, if using SFA in a recipe, it is recommended to use egg whites only for the initial emulsification process to avoid a very runny outcome, leading to a tackier batter.

### Example 2

A foodstuff comprising a thin pizza base in accordance with a first embodiment of the invention, preferably using an oven with fan forced grill, air fryer or microwave to cook the product, is as follows:

### Ingredients

1 egg
60 ml of olive oil
60 g of melted butter
50 g of cold smoked whey protein concentrate 80
270 g shredded parmesan

### Method

1. Crack the whole egg and then place with the olive oil and the melted butter into a suitable mixing container. Preferably, the liquids are layered starting with the olive oil first and then the butter on second.
2. In the suitable mixing container blend the egg and the liquids with an electric stick blender/hand mixer for 30 seconds, starting on the bottom and moving it along the bottom as it instantly starts emulsifying where you are mixing, then in an up and down motion until the mixture gets completely thick.
3. Fold in the smoked whey protein concentrate, until it is thoroughly mixed through.
4. Place the product from the mixing container onto a square piece of greaseproof paper and spread in an outward motion until a thin pizza size circle of about 30 cm in diameter is spread over the paper evenly.
5. Place shredded parmesan cheese evenly spread over the seasoned base.
6. Use hands to flatten out any thick spots.
7. Place the greaseproof paper with the seasoned product directly onto the top rack of a fan-forced grill with the aid of a chopping board to help transfer without losing the cheese everywhere, preheated to about 190° C. for about 2 to about 3 minutes and depending on the oven heat distribution, it may be necessary to rotate the paper 180° to cook evenly and golden.
8. Remove from the oven and flip on the greaseproof paper and flatten any high spots while it is hot and malleable.
9. Use pizza sauce to coat the base and add cheese and other the fillings with more cheese on top, before cooking in the oven or air frier accordingly until the cheese is goldened and the filling are cooked throughout.
10. Optionally, once the pizza base has cooled down, it may be vacuum packed, such as by using Cryovac™ packaging, for later storage in a cool, dry place.

Cold smoked WPC80 improves texture, flexibility, and flavour. As would be appreciated by the person skilled in the art, this can be achieved by using known cold smoking techniques until whey has changed from a white to dark yellow colour. This process also required stirring which will allow the lighter non smoked portions to surface and change colour. This process takes at least an hour and can be pre done.

### Example 3

A foodstuff comprising a ‘deep pan pizza’ in accordance with a first embodiment of the invention, preferably using an air fryer or fan forced oven to bake or grill to cook the product, is as follows:

### Ingredients

1 egg
60 ml of olive oil
60 g of macadamia nut oil
50 g of whey protein concentrate 80
70 g shredded parmesan
½ teaspoon of bicarbonate of soda

### Method

1. Crack the whole egg and then place with the olive oil and the macadamia oil into a suitable mixing container.
2. In the suitable mixing container blend the egg and the liquids with an electric stick blender/hand mixer for 30 seconds, starting on the bottom and moving it along the bottom as it instantly starts emulsifying where you are mixing, then in an up and down motion until the mixture gets completely thick.
3. In an airtight container add the bicarb and WPC 80, then thoroughly shake the bicarb and WPC80, to create a consistent blend.
4. Add the whey protein concentrate blend and fold in until mixed thoroughly.
5. Place the product from the mixing container onto a square piece of greaseproof paper and place another oiled sheet of greaseproof paper over the top and press on the product to spread in outward to create a nice an even thickness to the pizza shape, then remove to top sheet.
6. Place shredded parmesan cheese evenly spread over the base.
7. Use hands to flatten out any thick spots.
8. Place the greaseproof paper with the prepared product directly onto the top rack of a fan-forced grill with the aid of a chopping board to help transfer without losing the cheese everywhere. The oven should be preheated to about 190° C. for about 2 to about 3 minutes and depending on the oven heat distribution, it may be necessary to rotate the paper about 180°to cook evenly, until puffy and golden.
9. Remove from the oven and flip on the greaseproof paper and use pizza sauce to coat the base and add cheese and other the fillings with more cheese on top, before cooking in the oven or air frier accordingly until the cheese is goldened and the filling are cooked throughout.
10. This can also be used to make a focaccia. In step 5, rather than a round pizza shape, make an oval focaccia shape and after step 9, simply cut down the centre of both directions to create quarters or twice on the long side to create sixths, which can be later used as a slice.
11. This can also be used to make a burger bun. At step 6 you divide the dough batter into 6 equal portions, place a second oiled sheet of baking paper over the top of the portions, individually press all six with a 21 cm diameter tin lid, then sprinkle the top with parmesan cheese and/or any other toppings
12. Optionally, once the product has cooled down, it may be vacuum packed, such as by using Cryovac™ packaging, for later storage in a cool, dry place.

### Example 4

A foodstuff comprising a ‘pie or quiche’ in accordance with a first embodiment of the invention, preferably using an air fryer or fan forced oven to bake or grill to cook the product, is as follows:

### Ingredients

1 egg
60 ml of olive oil
60 g of walnut oil
50 g of whey protein concentrate 80
2.5 ml of sesame seed oil
70 g shredded parmesan
Seasoning
   I. ¼ tsp garlic powder
   II. ¼ tsp ground oregano
   III. ¼ tsp pepper
   IV. ½ tsp onion powder
   V. ½ tsp smoked paprika

### Method

1. Crack the egg and place the egg, the olive oil, the walnut and sesame seed oil in a suitable mixing container. Preferably, the liquids are layered starting with the olive oil first and then the sesame seed oil, then lastly, the walnut oil.
2. In the suitable mixing container blend the egg and oils with an electric stick blender/hand mixer for 30 seconds, starting on the bottom and moving it along the bottom as it instantly starts emulsifying where you are mixing, then in an up and down motion until the mixture gets completely thick.
3. Fold in the whey protein concentrate, until it is thoroughly mixed through.
4. Place the product from the mixing container onto a square piece of greaseproof paper and spread in an outward motion to create a thin circle to an even thickness.
5. Sprinkle the individual seasonings or by using a premixed combination evenly over the spread-out base.
6. Place shredded parmesan cheese evenly spread over the seasoned base.
7. Use hands to flatten out any thick spots.
8. Place the greaseproof paper with the seasoned product directly onto the top rack of a fan-forced grill with the aid of a chopping board to help transfer without losing the cheese everywhere, preheated to about 190° C. for about 2 to about 3 minutes and depending on the oven heat distribution, it may be necessary to rotate the paper about 180° to cook evenly and golden.
9. Remove from the oven and place seasoned side down in a Pyrex style pie or quiche container shaping it while it is hot and malleable. 10. Add fillings and cook in the oven accordingly to cook the filling throughout. 11. Alternatively, you can spread the product to cover a suitable baking container that you want to use for a pie or quiche and bake for 10 to 15 minutes @ 120-130 degrees Celsius. (This alternative does not incorporate seasoning or cheese)

Note that if you wanted to make a sweet pie, just add the appropriate sweetener with the other dry ingredients to blend, before mixing with the wet ingredients in step 5. This option works best with the baking cooking method of step 11, above, not grilling.

### Example 5

A foodstuff comprising an ‘egg white only’ pizza base in accordance with a first embodiment of the invention, preferably using a commercial gas or electric impingement pizza oven to cook the product, is as follows:

### Ingredients

45 g egg white
125 ml of olive oil
50 g of whey protein concentrate 80

### Method

1. Pour egg white from an egg white only carton and the olive oil in a suitable mixing container.
2. In the suitable mixing container blend the egg white and the olive oil with an electric stick blender/hand mixer for 30 seconds, starting on the bottom and moving it along the bottom as it instantly starts emulsifying where you are mixing, then seconds in an up and down motion until the mixture gets completely thick.
3. Fold in the whey protein concentrate, until it is thoroughly mixed through
4. Place the product from the mixing container onto a square piece of greaseproof paper and then place another oiled sheet of baking paper over the top. Now with deep pan pizza lid, place the lid upside down so that the indent from the lipped edge can serve as a mould, onto the top sheet and press on the inside edge of the lid to spread it around. Lift the lid and if uneven then place the lid back on and press down and slide your fist towards the lacking area and once it is all even, then remove the top sheet too.
5. Clean up the edges that squeezed out and use that to fill any holes.
6. Place the greaseproof paper with the prepared product directly onto the conveyer belt of a commercial pizza oven, preheated to about 190° C. for about 45 seconds to about 1 minute and depending on the fastest belt speed setting you may need to remove from the side oven door half way so it is nice and golden.
7. After removing from the oven and letting cool down, then Cryovac in packs of 2 to freeze for future use.
8. For optimal result, when making a pizza to cook, use the frozen base and before placing the base in a pizza pan, cut from a 3 mm Silicon rubber a circle to cover the pizza pans base and then place the frozen base on the Silicon, ready to assemble and cook at normal commercial pizza oven settings.

Notably, this option may be suitable for a commercial application as it removes the complexities and risks of separating the egg white and yolk, such that pre-packaged egg whites may be used for batch processing, which removes the risk of salmonella poisoning.

### Example 6

A foodstuff comprising a “bread loaf” in accordance with a first embodiment of the invention, preferably using an air fryer or fan forced oven to bake to cook the product, is as follows:

### Ingredients

160 g of egg white
120 ml of olive oil
120 ml of macadamia nut oil
60 g of melt butter
5 ml of sesame seed oil
100 g of whey protein concentrate 80
1 teaspoon of bicarbonate of soda
¼ teaspoon of cream of tartar
¼ teaspoon of pink Himalayan salt.

### Method

1. Pour egg white, olive oil, macadamia nut oil and sesame seed oil in a suitable mixing container.
2. In the suitable mixing container blend the egg white and all of the oils with an electric stick blender/hand mixer for 60 seconds, starting on the bottom and moving it along the bottom as it instantly starts emulsifying where you are mixing, then in an up and down motion until the mixture gets completely thick.
3. In an airtight container add all of the dry ingredients, then thoroughly shake the salt, cream of tartar, bicarb and WPC80, to create a consistent blend.
4. Scrape out the emulsified egg and oil into a medium bowl, then empty the dry ingredients from the airtight container and fold in the whey protein concentrate blend, until it is thoroughly mixed through.
5. Place the product from the mixing bowl into an oiled rectangle bread loaf tin and spread it evenly in the tin.
6. Place the bread loaf tin, into a pre heated fan forced oven to 120-130 degrees Celsius and cook for 25-35 minutes. If the bread loaf raises unevenly then, rotate 180 degrees to lift the lacking side.
7. Use a satay stick to place into the loaf down to the bottom of the tin and check if the stick is wet or dry to see if you need to continue to cook.
8. Once the loaf is full cooked and stick returns dry, remove the loaf from the oven and remove from tin to cool.
9. Once cooled store in airtight container in a cool dry place or in the fridge for future use.
10. Slice as required and either toast plain or under the grill or air fryer to toast with cheese on top.

### Example 7

A ‘core process’ for producing a foodstuff, such as a dough, in accordance with a second embodiment of the invention is as follows:

### Ingredients

100 g of semi-soft cheese (known for texture)
25 g of hard cheese (known for flavour)
75 g of whey protein concentrate 80 or other protein concentrates
   Method 1. Place all of the semi-soft cheese in a suitable microwave bowl and microwave on high for about 20 sec, then with a spoon, fold the melted hotter section in with less melted section in the middle until more consistent. Then repeat for a further period of about 10 sec. It is to be noted that soft cheese may be used in other embodiments in place of the semi-soft cheese.
2. Add all the hard cheese to the melted semi-soft cheese and fold it through, then microwave for a final period of about 10 sec and fold through again, now everything is melted.
3. Add all the whey protein concentrate WPC 80 to the melted cheese and fold continually with a spoon. Once it is partially combined, use hands to knead in the remainder of the WPC80 and once all the ingredients are combined, a dough like product will be produced.
4. Using two sheets of non-stick cooking paper, place the dough in the centre and use a rolling pin to roll out as thin as possible.
5. Using a pasta rolling machine, run 5 cm (or thereabouts) lengths of the flattened dough through the pasta roller starting with setting 9 (the largest) and continue to do so, going down 1 level at a time, until the dough is at the desired thickness (depending on the intended use).
6. Note, depending on the desired finished product, it may be necessary to season and/or cook the dough either in an air fryer to make crackers (seasoning required) or using the uncooked/unseasoned sheets as part of the layers in a lasagne which will cook in the oven as part of the lasagne's cooking process.

### Example 8

A foodstuff comprising ‘crackers’ in accordance with a second embodiment of the invention is as follows:

### Ingredients

100 g of mozzarella cheese
25 g of parmesan cheese
75 g of whey protein concentrate 80
Seasoning
   I. ¼ tsp garlic powder
   II. ¼ tsp ground oregano
   III. ¼ tsp mixed herbs
   IV. ¼ tsp pepper
   V. ½ tsp onion powder
   VI. ½ tsp smoked paprika

### Method

1. Place all the Mozzarella cheese in a suitable microwave bowl and microwave on high for about 20 sec, then with a spoon, fold the melted hotter section in with less melted section in the middle until more consistent. Then repeat for a further period of about 10 sec.
2. Add all the Parmesan cheese to the melted Mozzarella and fold it through, then microwave for a final period of about 10 sec and fold through again, now everything should be melted.
3. Add all the whey protein concentrate WPC 80 to the melted cheese and fold continually with a spoon. Once it is partially combined, use hands to knead in the remainder of the WPC80 and once all the ingredients are combined, a dough like product will be produced.
4. Using two sheets of non-stick cooking paper, place the dough in the centre and use a rolling pin to roll out as thin as possible.
5. Using a pasta rolling machine, run 5 cm lengths (or thereabouts) of the flattened dough through the pasta roller starting with setting 9 (the largest) and continue to do so, going down 1 level at a time, until the dough has gone through the roller on level 2.
6. Slice into the desired shape i.e., strips, squares, rectangles, triangles etc. Then place into a bowl of seasoning to coat both sides.
7. Place all the uncooked seasoned crackers on a rack and cook in the air-fryer on about 220° C. for about 90 to about 120 seconds until golden in colour. Turn any non-golden pieces, remove the golden ones and place back in for about 30 sec. Once all cooked let cool for a few minutes to harden.

Note for a crunchier cracker, you can first cook in a microwave after seasoning the uncooked cracker for about 20 seconds to activate it, then continue with step 7 to cook further in the air-fryer.

### Example 9

A foodstuff comprising a ‘lasagne sheet’ in accordance with a second embodiment of the invention is as follows:

### Ingredients

100 g of mozzarella cheese
25 g of parmesan cheese
75 g of whey protein concentrate 80
   Method 1. Place all the Mozzarella cheese in a suitable microwave bowl and microwave on high for about 20 sec, then with a spoon, fold the melted hotter section in with less melted section in the middle until more consistent. Then repeat for a further period of about 10 sec. 2. Add all the Parmesan cheese to the melted Mozzarella and fold it through, then microwave for a final period of about 10 sec and fold through again, now everything is melted. 3. Add all the whey protein concentrate WPC 80 to the melted cheese and fold continually with a spoon. Once it is partially combined, use hands to knead in the remainder of the WPC80 and once all the ingredients are combined a dough like product is produced.
5. Using two sheets of non-stick cooking paper, place the dough in the centre and use a rolling pin to roll out as thin as possible.
5. Using a pasta rolling machine, run 5 cm lengths (or thereabouts) of the flattened dough through the pasta roller starting with setting 9 (the largest) and continue to do so, going down 1 level at a time, until the dough has gone through the roller on level 4.
6. These sheets can be frozen for future use, otherwise assemble the lasagne.

### Example 10

A foodstuff comprising a ‘dumpling coating’ in accordance with a first embodiment of the invention, using an air fryer to cook the product or boiling in a broth, is as follows

### Ingredients

1 egg
120 g of melted butter
50 g of whey protein
Premade & cooked meatballs

### Method

1. Separate the egg white from the yolk and place the egg white and the melted butter in a suitable mixing container.
2. In the suitable mixing container blend the egg white and the melted butter with an electric stick blender/hand mixer for 30 seconds, starting on the bottom and moving it along the bottom as it instantly starts emulsifying where you are mixing, then in an up and down motion until the mixture gets completely thick.
3. Add the egg yolk and mix for a further 20-30 seconds, this will thin out the thicker emulsified texture to a slightly runnier texture.
4. Now fold in the whey protein concentrate, until it is thoroughly mixed through
5. Collect the pre-made cooked meatballs, that have cooled down from the fridge.
6. Spear a meatball with a skewer and spread a thin layer of the batter/dough over the meatball.
7. Either boil the coated meatball in a broth for 1 minute or air fry for 2 minutes turning after 1 minute.
8. Either serve with sauces if air fried or in a hot broth if boiled.

### Example 11

A foodstuff comprising an “dessert cake” in accordance with a first embodiment of the invention, preferably using an air fryer or fan forced oven to bake to cook the product, is as follows:

### Ingredients

160 g of egg white
120 ml of macadamia nut oil
120 ml of coconut oil
60 g of melt butter
100 g of whey protein concentrate 80
100 g of Fossence
1 teaspoon of bicarbonate of soda

### Method

1. Pour egg white, macadamia nut oil, coconut oil and melted butter in a suitable mixing container.
2. In the suitable mixing container blend the egg white and all of the liquids with an electric stick blender/hand mixer for 60 seconds, starting on the bottom and moving it along the bottom as it instantly starts emulsifying where you are mixing, then in an up and down motion until the mixture gets completely thick.
3. In an airtight container add all of the dry ingredients, then thoroughly shake the Fossence, bicarb and WPC80, to create a consistent blend.
4. Scrape out the emulsified egg and oil into a medium bowl, the empty the dry ingredients from the airtight container and fold in the whey protein concentrate blend, until it is thoroughly mixed through.
5. Place the product from the mixing bowl into an oiled ring cake tin and spread it evenly in the tin.
6. Place the ring cake tin, into a pre heated fan forced oven @ 120-130 degrees Celsius and cook for 25-35 minutes. If the cake raises unevenly then, rotate 180 degrees to lift the lacking side.
7. Use a satay stick to place into the cake, down to the bottom of the tin and check if the stick is wet or dry to see if you need to continue to cook.
8. Once the cake is fully cooked and stick returns dry, remove the cake from the oven and remove the cake from tin to cool.
9. Once cooled store in airtight container in a cool dry place or in the fridge for future use.
10. Slice as required and have either plain or toast under the grill or air fryer for a different taste experience.

Examples of the present invention improve upon bread replacement concepts with new ingredients and processing. WPC has substantial nutritional benefits, but it is not particularly palatable when cooked as it goes increasingly dry, which is why it was previously limited to protein shakes and bars or added to recipes in very small amounts to be able to use it as a significant descriptor, indicator, or label of the food product's composition. However, with the presently described processes, WPC can be substituted for flour and transformed into products like pizza base, focaccia, bread loaf, burger bun, pie crust, dumplings, dessert bread/cakes, crackers, lasagne sheets etc. Using the process of embodiments of the present invention, it is possible to create a high fat and protein batter/dough that can be used for various outcomes through different processes.

The goal for these variations to the core ingredients and process are used to provide healthy but still tasty alternatives to current comfort food.

As described herein, a preferred form of whey protein concentrate is WPC80. However, other forms of whey protein concentrate are envisaged to be useful in the present invention for producing a low carbohydrate food product, such as for example whey protein isolate (WPI), and whey protein hydrolysate (WPH) but they are less desirable due to the increased cost.

Furthermore, other high quality protein sources may be used, such as for example, Casein protein, Egg protein, Fava bean protein, spirulina protein, Pea protein, Hemp protein, Brown rice protein & Mixed plant proteins.

As described herein, eggs are used in a number of examples. In particular, and in preferred forms, egg sizes are chosen for the process of producing a low carbohydrate food product. Preferred egg sizes are about 58 grams but may range from about 50 grams to about 67 grams.

In various embodiments, the present invention provides:

Two methods of preparing and/or cooking of low-carbohydrate and gluten-free food products comprising the steps of combining whey protein concentrate with two variations of food stuff ingredients and processes comprising of either one, emulsified egg white and edible oils (MUFAs, PUFAs, & SFAs) or two, melted cheese/s.

The step of combining whey protein concentrate with the foodstuff ingredients is performed after an oily, stable, thick substance is prepared using one of the two processes.

The two processes can be used to prepare food products ready for combining whey protein concentrate, the 1^{st} process consisted of foodstuff ingredients comprising of a combination of:
a) Egg white with or without the egg yolk
b) Edible fats or oils (MUFAs, PUFAs, & SFAs) i.e., olive oil, butter, coconut oil, sesame seed oil, etc.

The two processes can be used to prepare food products, the 2^{nd} process consisted of foodstuff ingredients comprising of a combination of:
c) Melted semi-soft cheese known for texture (i.e., mozzarella, edam), or alternatively, soft cheese
d) Grated hard cheese known for flavour (i.e., parmesan, red Leicester) added to the melted cheese.

The step of combining the whey protein concentrate with the foodstuff ingredients of either process of item 3 or 4, to form a dough.

Apparatus adapted to preparing process one a low-carbohydrate and gluten-free food product, said apparatus may include:
a) Stick blender/hand mixer means adapted to operate in accordance with a predetermined instruction set, following above items.
b) Oven grill means adapted to operate in accordance with a predetermined instruction set, said apparatus, in conjunction with said instruction set, being adapted to perform the method steps as set out herein.

Apparatus may be provided which is adapted to preparing a low-carbohydrate and gluten-free food product, said apparatus including: microwave means adapted to operate in accordance with a predetermined instruction set. Oven style air-frier means adapted to operate in accordance with a predetermined instruction set may be provided. Pasta rolling machine means adapted to operate in accordance with a predetermined instruction may be provided where, said apparatus, in conjunction with said instruction set, being adapted to perform the method steps as set out herein.

Unlike other known recipes, embodiments of the invention show baking powder/bicarbonate of soda will aerate & soften the texture of the resultant dough when blended with all dry ingredients before adding any wet ingredients.

Spirulina can be used as a replacement protein completely or partly. When using it as a complete replacement there is a step of microwaving to activate prior to the oven or air fry, but proof of concept has been achieved. This may be expensive to be used but as it is earmarked as a superfood and future global protein food solution, prices should become more economical over time.

To create a burger bun the deep pan pizza ratio has been slightly altered and divided into 6 equal portions and topped with parmesan before cooking.

An extra ¼ cup of oil may be added to the recipe to create a basic bread loaf. This also has the addition of bicarb to aerate the final product Additional recipes in accordance with embodiments of the invention are as follows.

It is to be noted that cold smoked WPC80 improves texture, flexibility, and flavour.

### Health Over Flavour Pizza Base

### Ingredients

1 egg
½ cup carbonated of olive oil
½ teaspoon of sesame seed oil
⅝ cup of whey protein concentrate 80
70 g shredded parmesan
Seasoning
¼ tsp garlic powder
¼ tsp ground oregano
¼ tsp pepper
½ tsp onion powder
½ tsp smoked paprika

### Method

1. Using home carbonated soft drink machine, substitute water for olive oil as though you were making soda water.
2. Separate the egg white from the yolk and place the egg white and the olive oil in a suitable mixing container.
3. In the suitable mixing container blend the egg white and the olive oil with an electric stick blender/hand mixer for 60 to 90 seconds in an up and down motion until the mixture gets thick.
4. Add the egg yolk and mix for a further period of about 20 to about 30 seconds.
5. Fold in the whey protein concentrate, until it is thoroughly mixed through
6. Place the product from the mixing container onto a square piece of greaseproof paper and spread in an outward motion until a thin base of desired shape is spread over the paper evenly.
7. Sprinkle the individual seasonings or by using a premixed combination evenly over the spread-out base.
8. Place shredded parmesan cheese evenly spread over the seasoned base.
9. Use hands to flatten out any thick spots.
10. Place the greaseproof paper with the seasoned product directly onto the top rack of a fan-forced grill with the aid of a chopping board to help transfer without losing the cheese everywhere, preheated to about 190° C. for about 2 to about 3 minutes and depending on the oven heat distribution, it may be necessary to rotate the paper about 180° to cook evenly and golden.
11. Remove from the oven and proceed with the relevant steps to complete a pizza, breakfast slice or pie/quiche.

### Alternative Protein Pizza Base

### Ingredients

1 egg
¼ cup of olive oil
¼ cup of walnut oil
5/8 cup of faba bean protein powder
½ teaspoon of sesame seed oil
70 g shredded parmesan

### Method

1. Separate the egg white from the yolk and place the egg white, sesame seed oil and ¼ cup olive oil in a suitable mixing container.
2. In the suitable mixing container blend the egg white and the oils with an electric stick blender/hand mixer for 60 seconds in an up and down motion until the mixture gets thick.
3. Slowly drizzle in ¼ cup of walnut oil while the stick blender/hand mixer is spinning. As more oil is added the liquids continue to emulsify and continue to get thicker as all the oil is added at the rate of a drizzle. This mixing process is approximately 60 to 90 seconds in total.
4. Add the egg yolk and mix for a further period of about 20 to about 30 seconds.
5. Fold in the faba bean protein powder, until it is thoroughly mixed through.
6. Place the product from the mixing container onto a square piece of greaseproof paper and spread in an outward motion until a thin pizza size circle of approx. 30 cm in diameter is spread over the paper evenly.
7. Place shredded parmesan cheese evenly spread over the seasoned base.
8. Use hands to flatten out any thick spots.
9. Place the greaseproof paper with the seasoned product directly onto the top rack of a fan-forced grill with the aid of a chopping board to help transfer without losing the cheese everywhere, preheated to about 190° C. for about 2 to about 3 minutes and depending on the oven heat distribution, it may be necessary to rotate the paper 180° to cook evenly and golden.
10. Remove from the oven, flip on the greaseproof paper, and flatten any high spots while it is hot and malleable.
11. Use pizza sauce to coat the base and add cheese and other the fillings with more cheese on top, before cooking in the oven or air frier accordingly until the cheese is goldened and the filling are cooked throughout.

### Spirulina Proof of Concept

### Ingredients

1 egg
½ cup of olive oil
½ cup of spirulina

### Method

1. Separate the egg white from the yolk and place the egg white and ¼ cup olive oil in a suitable mixing container.
2. In the suitable mixing container blend the egg white and the oils with an electric stick blender/hand mixer for 60 seconds in an up and down motion until the mixture gets thick.
3. Slowly drizzle in ¼ cup of olive oil while the stick blender/hand mixer is spinning. As more oil is added the liquids continue to emulsify and continue to get thicker as all the oil is added at the rate of a drizzle. This mixing process is approximately 60 to 90 seconds in total.
4. Add the egg yolk and mix for a further period of about 20 to about 30 seconds.
5. Fold in the spirulina, until it is thoroughly mixed through.
6. Scoop 3 g of the dough and flatten out on a sheet of grease proof paper to the size of a 20-cent piece
7. Place sheet in a 900w microwave for approx. 30 to 45 sec to activate the chips.
8. Place the greaseproof paper sheet directly onto the top rack of a fan-forced grill with the aid of a chopping board to help transfer without losing the chips everywhere, preheated to about 190° C. for about 1 to about 2 minutes and depending on the oven heat distribution, it may be necessary to rotate the paper 180° to cook evenly and crisp up.
9. Remove from the oven, season with pink Himalayan salt, and let cool down before eating.
10. Store in an airtight container.

### Commercial Pizza Base

### Ingredients

125 ml of olive oil
50 g of whey protein concentrate 80

### Method

1. In the suitable mixing container blend the egg white and the oil at the rate of a drizzle with a 5-7kg bench top mixer until all the oil is mixed in and the mixture gets thick.
2. Fold in the whey protein concentrate, until it is thoroughly mixed through.
3. Place 150 g of the product from the commercial mixer onto a square piece of greaseproof paper and flatten under a moulded hand press to form a 10″ pizza base.
4. Place the greaseproof paper onto conveyer belt of commercial pizza oven with temperature set at 190° C. and speed set to 2 minutes to cook until golden.
5. Remove from the oven & freeze for future use.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, any means plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures. More specifically, modifications and variations to the described examples herein are intended to be included within the disclosure of the present application. For instance, Example 1 described herein is a broad illustration of core process 1, where Examples 2 to 6 and 10 to 11 are different recipes showing the versatility of core process
1. Example 7 described herein is a broad illustration of core process 2, where Examples 8 to 9 are different recipes showing the versatility of core process 2.

The following sections I-Vii provide a guide to interpreting the present specification.

### I. Terms

The term “MUFA” means monounsaturated fats which are typically found in olive oil, canola oil, and in macadamia and most other nuts, as well as avocados. MUFAs are usually liquid at room temperature.

The term “PUFA” means polyunsaturated fats. These fats are always liquid both at room temperature and at refrigerator temperatures. They are found mostly in oils from vegetables, seeds, and some nuts like walnuts. Sunflower, safflower, flaxseed, soybean, corn, cottonseed, grape seed, and sesame oils are high in PUFAs. The oils in fatty fish such as sardines, herring and salmon are also high in PUFA's.

The term “SFA” means saturated fatty acids and they tend to remain solid at room temperature. Butter, lard, suet and palm and coconut oils are relatively rich in saturated fats. This type of fat is fine to consume on an Atkins-type diet because we know that the body burns primarily fat on Atkins, and we know from published research that the level of saturated fat in the blood when you are following Atkins does not increase.

The term “TRFT” means trans fats which should be avoided at all costs. An increased intake of trans fats is associated with an increased heart attack risk, and they have been shown to increase the body's level of inflammation. They are typically found in foods that should be avoided including fried foods, baked goods, cookies, crackers, candies, snack foods, icings and vegetable shortenings. To be sure there are no trans fats in a product, the list of ingredients should be checked and, where trans fats are listed as “shortening” or “hydrogenated vegetable oil” or “partially hydrogenated vegetable oil.” Any of these ingredients should be avoided in a healthy diet. Deep-fried foods in fast food and other restaurants should also be avoided.

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this specification”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present specification, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things, does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 2, 3, 4, . . . 9) and non-whole numbers (e.g., 1.1, 1.2, . . . 1.9).

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

IV. Disclosed Examples and Terminology Are Not Limiting Neither the Title nor the Abstract in this specification is intended to be taken as limiting in any way as the scope of the disclosed invention(s). The title and headings of sections provided in the specification are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognise that the disclosed invention(s) may be practised with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is not a literal description of all embodiments of the invention(s). Also, the present disclosure is not a listing of features of the invention(s) which must be present in all embodiments.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

Where a process is described, in an embodiment the process may operate without any user intervention. In another embodiment, the process includes some human intervention (e.g., a step is performed by or with the assistance of a human).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise', 'comprising', 'includes', 'including’ and the like are to be construed in an inclusive sense as opposed to an exclusive or exhaustive sense; that is to say, in the sense of “including, but not limited to”.

I claim:

1. A method of preparing a low-carbohydrate food product comprising the steps of:
emulsifying a mixture of egg white with an edible fat/oil by one or a combination of;
blending so as to propagate emulsion throughout the mixture, or;
drizzling a thin stream of edible fat/oil into the egg white mixture and mixing to propagate emulsion throughout the mixture; then,
combining a dry protein powder with the emulsified egg white and edible fat/oil mixture to form one of a dough or a batter.

2. The method as claimed in claim 1, wherein the mixture of egg white includes egg yolk.

3. (canceled)

4. The method as claimed in claim 1, wherein the temperature of the egg white mixture is in the range of about 30° C. to about 40° C.

5. The method as claimed in claim 1, wherein the step of drizzling comprises applying a thin stream of the edible fat/oil into the egg white mixture at a rate in the range of about 0.5 ml per second to about 1.0 ml per second.

6. The method as claimed in claim 1, wherein the steps of emulsifying and combining are performed without a stick blender.

7. The method as claimed in claim 1, wherein the edible fat/oil comprises one or a combination of:
monounsaturated fats;
polyunsaturated fats;
essential fatty acids, and;
saturated fats; and
wherein the dry protein powder comprises one or a combination of:
whey protein concentrate;
WPC;
WPC80;
WPC90;
whey protein isolate;
whey protein hydrolysate;
protein hydrolysate;
spirulina;
casein protein;
egg protein;
fava bean protein;
pea protein;
hemp protein;
brown rice protein, and;
mixed plant proteins.

8. (canceled)

9. A low-carbohydrate food product comprising a mixture of egg white with an edible fat/oil wherein the food product is prepared in accordance with the method steps of claim 1.

10. A method of preparing a low-carbohydrate food product comprising the step of combining whey protein concentrate with foodstuff ingredients comprising one or a combination of:
egg white;
egg yolk;
edible fats or oils comprising at least one of sesame seed oil, olive oil, butter, and;
at least one cheese.

11. The method of claim 10, wherein the step of combining whey protein concentrate with the foodstuff ingredients is performed after mixing or combining the foodstuff ingredients.

12. The method of claim 10, wherein the edible fats or oils comprise one or a combination of:
monounsaturated fats;
polyunsaturated fats;
essential fatty acids, and;
saturated fats.

13. The method of claim 10, wherein the step of combining the whey protein concentrate with the foodstuff ingredients forms a dough or batter.

14. The method of claim 13, further comprising the steps of:
shaping the dough or batter, and;
cooking the dough or batter.

15. The method of claim 10, wherein the whey protein concentrate comprises WPC80.

16. The method of claim 10, where the foodstuff ingredients include the edible fats or oils and one or more of egg white and egg yolk, wherein the method further includes the step of:
preparing the egg and edible fats or oils for combining with the whey protein concentrate by an emulsification process.

17. The method of claim 16, wherein the step of preparing the egg and edible fats or oils for combining with the whey protein concentrate by and emulsification process is performed with one or a combination of:
a blender;
a mixer; and
a microwave oven,
wherein the blender or mixer is a stick blender and a hand mixer, respectively.

18. (canceled)

19. The method of claim 10, where the foodstuff ingredients include at least one cheese, wherein the method further includes the step of:
preparing the at least one cheese for combining with the whey protein concentrate by melting the at least one cheese.

20. The method of claim 19, wherein the step of preparing-is the at least one cheese for combining with the whey protein concentrate includes adding grated hard cheese to melted soft or semi-soft cheese.

21. (canceled)

22. A low-carbohydrate food product, comprising:
foodstuff ingredients comprising one or a combination of egg white, egg yolk, at least one cheese, and edible fats or oils including at least one of sesame seed oil, olive oil, and butter; and,
whey protein concentrate.

23. The low-carbohydrate food product of claim 22, wherein the whey protein concentrate comprises WPC 80, and wherein the edible fats or oils comprise one or a combination of:
monounsaturated fats;
polyunsaturated fats;
essential fatty acids, and;
saturated fats.

24. (canceled)

25. Apparatus adapted to prepare a low-carbohydrate food product, said apparatus including:
processor means adapted to operate in accordance with a predetermined instruction set,
said apparatus, in conjunction with said instruction set, being adapted to perform the method as claimed in claim 1.

26. (canceled)

27. (canceled)
